(19) United States
(12) Patent Application Publication
(10) Pub. No.: US 2025/0004256 A1
(43) Pub. Date: Jan. 2, 2025

(54) FIXED-FOCUS IMAGING LENS

(71) Applicant: Young Optics Inc., Hsinchu Science Park (TW)

(72) Inventor: YING-HSIU LIN, Hsinchu Science Park (TW)

(21) Appl. No.: 18/663,703

(22) Filed: May 14, 2024

(30) Foreign Application Priority Data
Jun. 28, 2023 (TW) 112124162

(51) Int. Cl. G02B 13/00

(52) U.S. Cl. CPC G02B 13/006; G02B 13/0045; G02B 13/008

(57) ABSTRACT

A fixed-focus imaging lens includes a first lens group, an aperture stop and a second lens group arranged in order from an object side to an image side of the fixed-focus imaging lens. A focal plane for visible light with a wavelength of 550 nm along an optical axis of the imaging lens is less than 0.01 mm. The fixed-focus imaging lens satisfies a condition of 45<LT/GD, where LT is a distance measured along the optical axis between two outermost lens surfaces with refractive powers at opposite ends of the imaging lens, and GD is a distance measured along the optical axis between the first lens group and the second lens group.

### CROSS-REFERENCE TO RELATED APPLICATION

This application claims the priority benefit of Taiwan application serial no. 112124162, filed Jun. 28, 2023. The entirety of the above-mentioned patent application is hereby incorporated by reference herein and made a part of this specification.

### BACKGROUND

### Field of the Invention

The invention relates to an imaging lens, particularly to a fixed-focus imaging lens designed for applications in security surveillance.

### Description of the Related Art

In recent years, electronic products with imaging capabilities have been applied in various fields, such as security surveillance, in-vehicle camera systems, and action cameras. Therefore, it is desirable to provide an imaging lens that achieves wide viewing angles, miniaturization, and high imaging quality. However, conventional wide-angle lenses, due to limitations in lens shape and material, are difficult to provide good imaging quality on a sensor with large target areas while meeting the demands for both wide filed of views and large apertures.

### BRIEF SUMMARY OF THE INVENTION

In order to achieve one or a portion of or all of the objects or other objects, one embodiment of the invention provides a fixed-focus imaging lens including a first lens group, an aperture stop and a second lens group arranged in order from an object side to an image side of the fixed-focus imaging lens. A total number of lenses with refractive powers of the imaging lens is 7 or 8, the first lens group comprises two plastic aspheric lenses, the second lens group comprises three plastic aspheric lenses, a lens in the first lens group closest to the object side is a glass lens, a diagonal field of view of the imaging lens ranges from 140 to 165 degrees, and a distance between a focal plane for infrared light with a wavelength of 850 nm and a focal plane for visible light with a wavelength of 550 nm along an optical axis of the imaging lens is less than 0.01 mm. The fixed-focus imaging lens satisfies a condition of 45<LT/GD, where LT is a distance measured along the optical axis between two outermost lens surfaces with refractive powers at opposite ends of the imaging lens, and GD is a distance measured along the optical axis between the first lens group and the second lens group.

Another embodiment of the invention provides a fixed-focus imaging lens including a first lens group, an aperture stop and a second lens group. The first lens group includes a first lens, a second lens and a third lens arranged in order from an object side to an image side of the fixed-focus imaging lens. The second lens group includes a fourth lens, a fifth lens, a sixth lens, and a seventh lens arranged in order from the object side to the image side. The aperture stop is disposed between the third lens and the fourth lens. The first lens and the fourth lens are glass lenses, the second lens, the third lens, the fifth lens, the sixth lens and the seventh lens are plastic aspheric lenses, a diagonal field of view of the imaging lens ranges from 140 to 165 degrees, and a distance between a focal plane for infrared light with a wavelength of 850 nm and a focal plane for visible light with a wavelength of 550 nm along an optical axis of the imaging lens is less than 0.01 mm. The fixed-focus imaging lens satisfies a condition of 45<LT/GD, where LT is a distance measured along the optical axis between two outermost lens surfaces with refractive powers at opposite ends of the imaging lens, and GD is a distance measured along the optical axis between the first lens group and the second lens group.

According to the above embodiments, meeting the designed characteristics and arrangement of optical components set forth in the above may, under the condition of possessing wide field of views and large apertures, achieve good imaging quality for both visible and infrared light imaging and may maintain good imaging quality even for imaging on a sensor with a large target area (for example, an image height up to 4.4 mm). In addition, in various embodiments of the invention, by well matching the glass/plastic lenses and spherical/aspheric lenses and using a glass lens for the lens closest to the object side, the fixed-focus imaging lens is allowed to withstand higher temperatures and a broad range of temperature variations, reduce manufacturing costs, and maintain high imaging qualities.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 is a schematic diagram of a fixed-focus imaging lens according to a first embodiment of the invention.

FIG. 2A and FIG. 2B show ray fan plots for visible light of the imaging lens illustrated in FIG. 1, and FIG. 3A and FIG. 3B show ray fan plots for infrared light of the imaging lens illustrated in FIG. 1.

FIG. 4 is a schematic diagram of a fixed-focus imaging lens according to a second embodiment of the invention.

FIG. 5A and FIG. 5B show ray fan plots for visible light of the imaging lens illustrated in FIG. 4, and FIG. 6A and FIG. 6B show ray fan plots for infrared light of the imaging lens illustrated in FIG. 4.

FIG. 7 is a schematic diagram of a fixed-focus imaging lens according to a third embodiment of the invention.

FIG. 8A and FIG. 8B show ray fan plots for visible light of the imaging lens illustrated in FIG. 7, and FIG. 9A and FIG. 9B show ray fan plots for infrared light of the imaging lens illustrated in FIG. 7.

### DETAILED DESCRIPTION OF THE INVENTION

In the following detailed description of the preferred embodiments, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. Further, “First,” “Second,” etc., as used herein, are used as labels for nouns that they precede, and do not imply any type of ordering (e.g., spatial, temporal, logical, etc.).

The term “lens” refers to an element made from a partially or entirely light-transmissive material with optical power. The material commonly includes plastic or glass.

In an imaging system, an object side may refer to one side of an optical path of an imaging lens comparatively near a subject to be picked-up, and an image side may refer to other side of the optical path comparatively near a photosensor.

A certain region of an object side surface (or an image side surface) of a lens may be convex or concave. Herein, a convex or concave region is more outwardly convex or inwardly concave in the direction of an optical axis as compared with other neighboring regions of the object/image side surface.

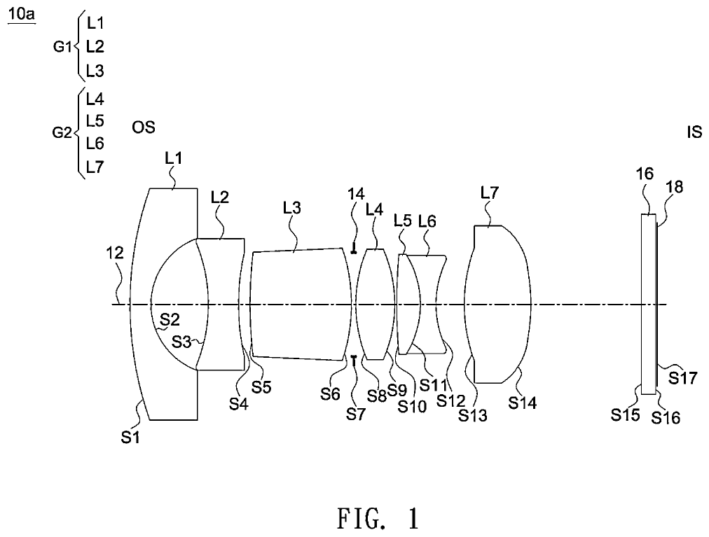

FIG. 1 is a schematic diagram of a fixed-focus imaging lens according to a first embodiment of the invention. Referring to FIG. 1, in this embodiment, the fixed-focus imaging lens 10a includes a first lens group G1, a second lens group G2, and an aperture stop 14 disposed between the first lens group G1 and the second lens group G2. The first lens group G1 has a negative refractive power and includes lenses L1, L2 and L3 arranged in order from the object side OS to the image side IS of the imaging lens 10a. The second lens group G2 has a positive refractive power and includes lenses L4, L5, L6 and L7 arranged in order from the object side OS to the image side IS. Additionally, a cover plate 16 and an image sensor (not shown) can be positioned on the image side IS. The cover plate 16 may be made from any suitable light-transmissive material, such as glass, and serves to adjust the overall length of the imaging lens and to provide a protective effect. The image plane of the imaging lens 10a on the image sensor is denoted as 18. Light from a subject to be captured enters the imaging lens 10a and sequentially passes through the lens L1, the lens L2, the lens L3, the aperture stop 14, the lens L4, the lens L5, the lens L6, the lens L7 and the cover plate 16, finally forming an image on the image plane 18.

In each of the following embodiments, the object side OS is located on the left side and the image side IS is located on the right side of each figure, which will not be reiterated below. In this embodiment, the aperture stop 14 is disposed between the lens L3 and the lens L4, and refractive powers of lenses L1 through L7 are respectively negative, negative, positive, positive, positive, negative, and positive. In this embodiment, the lenses L1 and L4 are glass spherical lenses, and the lenses L2, L3, L5, L6 and L7 are plastic aspherical lenses, but the invention is not limited to this configuration. The lens L5 and the lens L6 are paired together, such as being cemented to each other, to form a doublet lens to reduce chromatic aberrations and thus improve the production yield rate of the imaging lens 10a.

In at least some embodiments of the invention, the first lens group G1 may include three lenses with refractive powers where two of the three lenses are aspheric lenses, the lens in the first lens group G1 closest to the object side OS is a glass lens, and the second lens group G2 may include four lenses with refractive powers where at least three of the four lenses are aspheric lenses. In various embodiments of the invention, the number, shape, and optical characteristics of lenses may vary according to actual needs without limitation.

In at least some embodiments of the invention, the fixed-focus imaging lens may meet a condition of 45<LT/GD, where LT is a total lens length that is a distance measured along the optical axis 12 between two outermost lens surfaces with refractive powers at opposite ends of the imaging lens (such as the object-side surface S1 of the lens L1 and the image side surface S14 of the lens L7 shown in FIG. 1), and GD is a distance measured along the optical axis 12 between the first lens group G1 and the second lens group G2. In at least some embodiments of the invention, the fixed-focus imaging lens may meet a condition of 0.2<IMH/LT<0.3, where IMH is a maximum image height of the fixed-focus imaging lens, and the maximum image height may refer to half the diameter of a maximum image circle on the image plane 18. Meeting the condition of 0.2<IMH/LT<0.3 may allow for a balance between miniaturization and optical performance. In at least some embodiments of the invention, the fixed-focus imaging lens may meet a condition of 0.15<EFL/LT<0.25, where EFL is an effective focal length of the fixed-focus imaging lens, thereby providing an optimized proportion of the size of a photosensor to the total lens length LT. In this embodiment of the fixed-focus imaging lens 10a, LT=19.82 mm, GD=0.2 mm, IMH=4.4 mm, EFL=4.03 mm, LT/GD=99.1, IMH/LT=0.222, and EFL/LT=0.203.

In at least some embodiments of the invention, a back focal length (BFL) of the fixed-focus imaging lens ranges from 4 to 8 mm, where BFL denotes a distance measured along the optical axis 12 from an optical surface closest to the image side IS (such as the surface S14 of the lens L7 in FIG. 1) to the image plane 18. In this embodiment, the back focal length BFL of the fixed-focus imaging lens 10a is 6.18 mm. Furthermore, in at least some embodiments of the invention, an entrance pupil diameter of the fixed-focus imaging lens can be greater than 2 mm, and a total track length (TTL) of the fixed-focus imaging lens ranges from 24 to 28 mm, where TTL denotes a distance measured along the optical axis 12 from the optical surface closest to the object side OS (such as the surface S1 of lens L1 in FIG. 1) to the image plane 18.

A diagonal field of view (DFOV) refers to a light collection angle of the optical surface closest to the object side; that is, the DFOV is a full field of view measured diagonally. In at least some embodiments, the DFOV may range from 140 to 165 degrees. In this embodiment, the DFOV of the imaging lens 10a is 160 degrees.

The aperture stop 14 may use a mechanism to block peripheral light rays while allowing the central portion to transmit light, and this mechanism is adjustable. Herein, “adjustable” means that the position, shape, or transparency of the mechanism can be modified. In one embodiment, the aperture stop 14 is not an independent optical device but is instead defined by an inner diameter of the lens barrel. Alternatively, the aperture stop 14 can be created by applying an opaque, light-absorbing coating onto a lens surface, with the central portion of the lens surface left transparent to restrict the light path. In this embodiment, an F-number of the fixed-focus imaging lens 10a is 1.9.

Detailed optical data and design parameters of the fixed-focus imaging lens 10a are shown in Table 1 below. Note the data provided below are not used for limiting the invention, and those skilled in the art may suitably modify parameters or settings of the following embodiment with reference of the invention without departing from the scope or spirit of the invention.

Table 1 lists the values of parameters for each lens of an imaging system. The radius of curvature and interval shown in Table 1 are all in a unit of mm. The field heading “radius of curvature” shown in Table 1 is a reciprocal of the curvature. When a lens surface has a positive radius of curvature, the center of the lens surface is located towards the image side. When a lens surface has a negative radius of curvature, the center of the lens surface is located towards the object side. The field heading “interval” represents a distance between two adjacent surfaces along the optical axis 12 of the imaging lens 10a. For example, an interval of the surface S1 is a distance between the surface S1 and the surface S2 along the optical axis 12, and an interval of the surface S2 is a distance between the surface S2 and the surface S3 along the optical axis 12. Further, the interval, refractive index and Abbe number of any lens listed in the column of “Object description” show values in a horizontal row aligned with the position of that lens, so that related descriptions are omitted for sake of brevity.

TABLE 1

| | | Radius of | | | Abbe |
|---|---|---|---|---|---|
| | | curvature | Interval | Refractive | number |
| Object description | Surface | (mm) | (mm) | Index (nd) | (Vd) |
| lens L1(meniscus) | S1 | 20.49 | 1.04 | 1.77 | 49.6 |
| | S2 | 3.88 | 2.81 | | |
| lens L2(aspheric) | S3* | −12.83 | 1.54 | 1.54 | 56.11 |
| | S4* | 13.63 | 0.57 | | |
| lens L3(aspheric) | S5* | 17.03 | 4.98 | 1.65 | 21.52 |
| | S6* | −11.62 | 0.10 | | |
| aperture stop 14 | S7 | inf. | 0.10 | | |
| lens L4(bi-convex) | S8 | 8.02 | 1.94 | 1.59 | 68.62 |
| | S9 | −9.90 | 0.10 | | |
| lens L5(aspheric) | S10* | 19.41 | 1.21 | 1.54 | 56.11 |
| lens L6(aspheric) | S11* | −6.00 | 0.71 | 1.64 | 23.97 |
| | S12* | 5.27 | 1.45 | | |
| lens L7(aspheric) | S13* | 6.92 | 3.27 | 1.54 | 56.11 |
| | S14* | −14.16 | 5.44 | | |
| cover plate 16 | S15 | inf. | 0.70 | 1.52 | 64.17 |
| | S16 | inf. | 0.05 | | |
| image plane 18 | S17 | inf. | 0.00 | | |

An aspheric lens indicates at least one of its front lens surface and rear lens surface has a radius of curvature that varies along a center axis to correct abbreviations. In the following design examples of the invention, each aspheric surface satisfies the following equation:

$$Z = \frac{{cr}^{2}}{1 + \sqrt{1 - ( 1 + k ) {c}^{2} {r}^{2}}} + {Ar}^{4} + {Br}^{6} + {Cr}^{8} + {Dr}^{10} + {Er}^{12} + {Fr}^{14} + {Gr}^{16} + … ,$$

where Z denotes a sag of an aspheric surface along the optical axis 12, c denotes a reciprocal of a radius of an osculating sphere, K denotes a conic constant, r denotes a height of the aspheric surface measured in a direction perpendicular to the optical axis 12, and parameters A-G are 4th, 6th, 8th, 10th, 12th, 14th and 16th order aspheric coefficients. Note the data provided below are not used for limiting the invention, and those skilled in the art may suitably modify parameters or settings of the following embodiment with reference of the invention without departing from the scope or spirit of the invention.

TABLE 2

| | S3 | S4 | S5 | S6 | S10 |
|---|---|---|---|---|---|
| K | 0.00 | −3.97 | −40.54 | 3.32 | 0.00 |
| A | −3.38E−03 | −2.92E−03 | −1.66E−04 | 2.01E−04 | −1.23E-03 |
| B | 2.51E−04 | 3.87E−04 | −2.62E−05 | −3.00E−05 | 1.26E-05 |
| C | −1.19E−05 | −2.09E−05 | −8.02E−06 | −1.37E−06 | 1.52E-06 |
| D | 3.74E−07 | 3.48E−07 | 4.20E−07 | −6.89E−08 | −1.65E-06 |
| E | 4.97E−09 | 4.47E−08 | −6.91E−08 | 1.01E−08 | 1.10E-07 |
| F | −4.17E−10 | −2.67E−09 | — | — | — |

| | S11 | S12 | S13 | S14 |
|---|---|---|---|---|
| K | 1.14 | 1.30 | −6.52 | 7.84 |
| A | −7.30E−04 | −4.31E−03 | −7.79E−04 | −9.23E−04 |
| B | 7.73E−04 | 4.04E−04 | −3.04E−05 | −3.08E−05 |
| C | −2.65E−04 | −7.81E−05 | 1.34E−05 | 6.23E−06 |
| D | 3.79E−05 | 6.71E−06 | −3.22E−06 | −8.09E−07 |
| E | −2.02E−06 | −3.63E−07 | 3.01E−07 | 4.76E−08 |
| F | — | — | −1.23E−08 | −1.37E−09 |

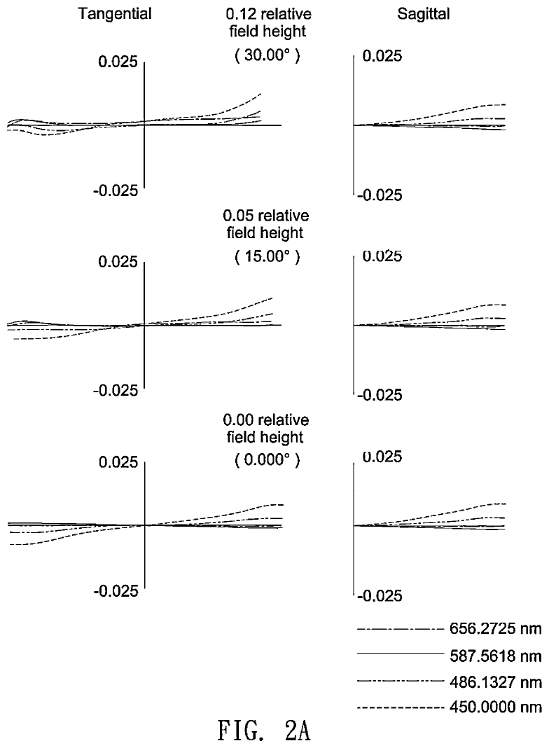

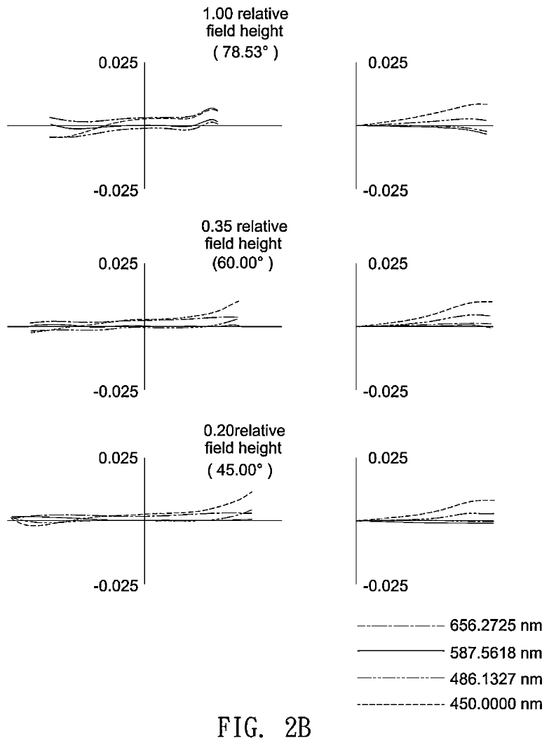

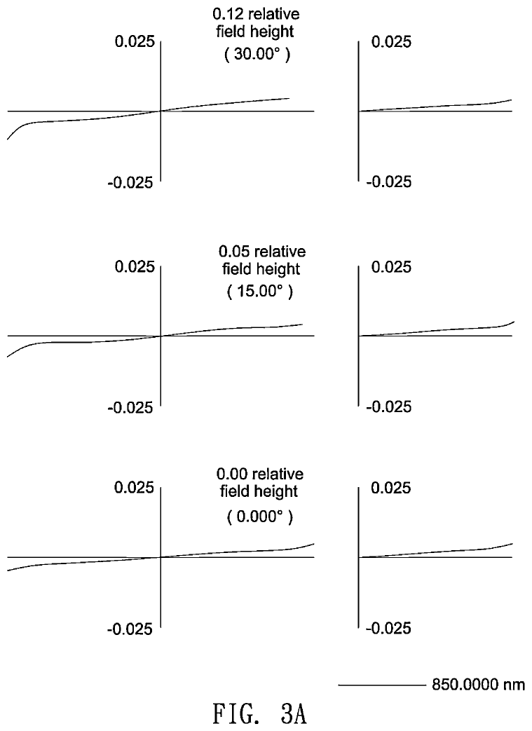

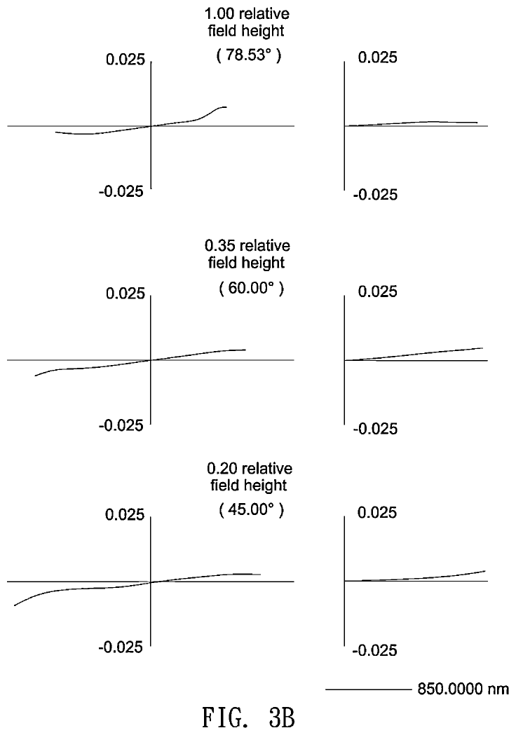

FIG. 2A, FIG. 2B, FIG. 3A and FIG. 3B show optical simulation results of the imaging lens 10a. FIG. 2A and FIG. 2B show ray fan plots for visible light, and FIG. 3A and FIG. 3B show ray fan plots for infrared light (850 nm), where an abscissa of the plot represents entrance pupil positions, and an ordinate of the plot represents relative numerical values of positions on an image plane where chief rays are projected. The optical simulation results for visible light and infrared light imaging shown in these plots are within permitted ranges specified by the standard, which indicates the above embodiment of the fixed-focus imaging lens 10a may achieve good imaging quality for both visible and infrared light.

Furthermore, in at least some embodiments of the invention, a distance between a focal plane for infrared light with a wavelength of 850 nm and a focal plane for visible light with a wavelength of 550 nm along the optical axis of the fixed focus imaging lens is less than 0.01 mm to achieve 24-hours confocal image-capturing capability.

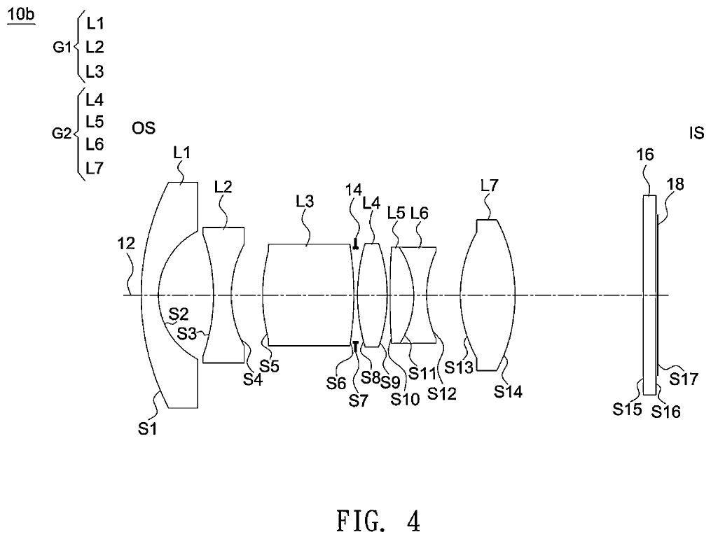

FIG. 4 is a schematic diagram of a fixed-focus imaging lens according to a second embodiment of the invention. In this embodiment, the fixed-focus imaging lens 10b includes a lens L1, a lens L2, a lens L3, a lens L4, a lens L5, a lens L6 and a lens L7 with refractive powers arranged in order from the object side OS to the image side IS, and the imaging lens 10b includes an aperture stop 14 disposed between the lens L3 and the lens L4. The refractive powers of the lens L1 to the lens L7 are respectively negative, negative, positive, positive, positive, negative, and positive. In this embodiment, the lens L1 is a glass spherical lens, the lens L4 is a molded-glass aspheric lens, and the lenses L2, L3, L5, L6 and L7 are plastic aspheric lenses, but the invention is not limited thereto. In this embodiment, the lens L5 and the lens L6 are paired together, such as being cemented to each other, to form a doublet lens to reduce chromatic aberrations of the imaging lens 10b and thus improve the production yield rate of the imaging lens 10b.

In this embodiment, the fixed-focus imaging lens 10b consists essentially of seven lenses with refractive powers. The diagonal field of view (DFOV) of the fixed-focus imaging lens 10b is 160 degrees, BFL=6.18 mm, LT=18.848 mm, GD=0.2 mm, IMH=4.4 mm, EFL-3.99 mm, LT/GD-94.24, IMH/LT=0.233, EFL/LT=0.212, and F #=2.0.

Detailed optical data and design parameters of the lenses and other optical components of the fixed-focus imaging lens 10b are shown in Table 3.

TABLE 3

| | | Radius of | | | Abbe |
|---|---|---|---|---|---|
| | | curvature | Interval | Refractive | number |
| Object description | Surface | (mm) | (mm) | index (nd) | (Vd) |
| lens L1(meniscus) | S1 | 14.69 | 0.87 | 1.77 | 49.6 |
| | S2 | 4.11 | 2.77 | | |
| lens L2(aspheric) | S3* | −18.48 | 0.96 | 1.54 | 56.11 |
| | S4* | 6.49 | 1.55 | | |
| lens L3(aspheric) | S5* | 10.34 | 4.58 | 1.66 | 20.37 |
| | S6* | −25.96 | 0.10 | | |
| aperture stop 14 | S7 | inf. | 0.10 | | |
| lens L4(aspheric) | S8* | 11.19 | 1.50 | 1.59 | 68.62 |
| | S9* | −8.53 | 0.10 | | |
| lens L5(aspheric) | S10* | 13.56 | 1.21 | 1.54 | 56.11 |
| lens L6(aspheric) | S11* | −7.14 | 0.65 | 1.64 | 23.97 |
| | S12* | 5.08 | 1.71 | | |
| lens L7(aspheric) | S13* | 6.25 | 2.74 | 1.54 | 56.11 |
| | S14* | −12.08 | 6.45 | | |
| cover plate 16 | S15 | inf. | 0.61 | 1.52 | 64.17 |
| | S16 | inf. | 0.09 | | |
| image plane 18 | S17 | inf. | 0.00 | | |

Table 4 shows the conic constant and aspheric coefficients for each aspheric surface of the fixed-focus imaging lens 10b.

TABLE 4

| | S3 | S4 | S5 | S6 | S8 | S9 |
|---|---|---|---|---|---|---|
| K | 0.00 | 2.05 | −14.19 | 55.16 | 0.00 | 0.00 |
| A | −4.09E−03 | −4.15E−03 | 1.02E−03 | −4.60E−04 | 2.38E−04 | −9.49E−05 |
| B | 3.76E−04 | 3.77E−04 | −1.36E−04 | 3.58E−05 | −3.15E−05 | −1.67E−05 |
| C | −3.09E−05 | −3.61E−05 | 3.89E−06 | −8.38E−06 | 4.34E−06 | 4.53E−06 |
| D | 1.83E−06 | 1.92E−06 | −6.13E−07 | 5.38E−07 | — | — |
| E | −5.60E−08 | −4.24E−08 | — | — | — | — |
| F | 6.44E−10 | — | — | — | — | — |

| | S10 | S11 | S12 | S13 | S14 |
|---|---|---|---|---|---|
| K | 0.00 | 3.87 | 0.70 | −8.59 | 6.75 |
| A | −3.68E−03 | −3.19E−03 | −5.88E−03 | 2.00E−03 | 2.05E−04 |
| B | 1.68E−04 | 3.65E−04 | 4.43E−04 | −2.37E−04 | 1.09E−05 |
| C | −9.99E−06 | −8.91E−05 | −5.35E−05 | 2.64E−05 | 9.05E−07 |
| D | −1.55E−06 | 1.58E−05 | 3.29E−06 | −2.21E−06 | 7.99E−09 |
| E | 1.72E−07 | −1.07E−06 | −1.32E−07 | 1.09E−07 | −9.25E−10 |
| F | — | — | — | −2.58E−09 | — |

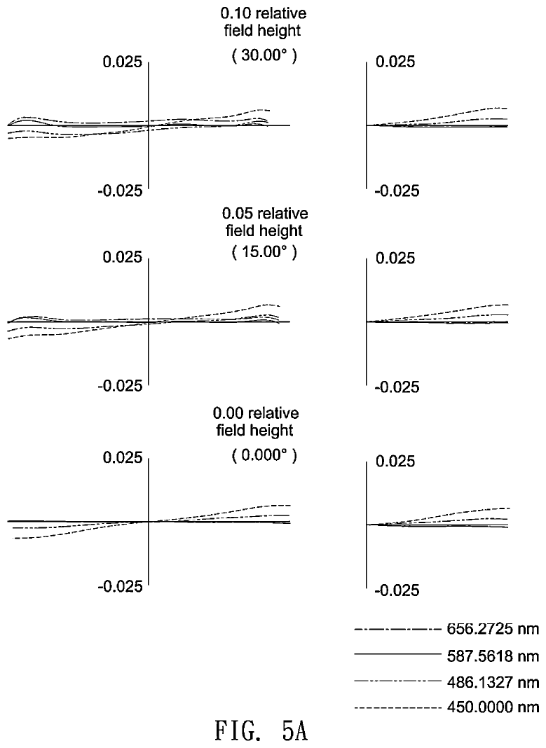

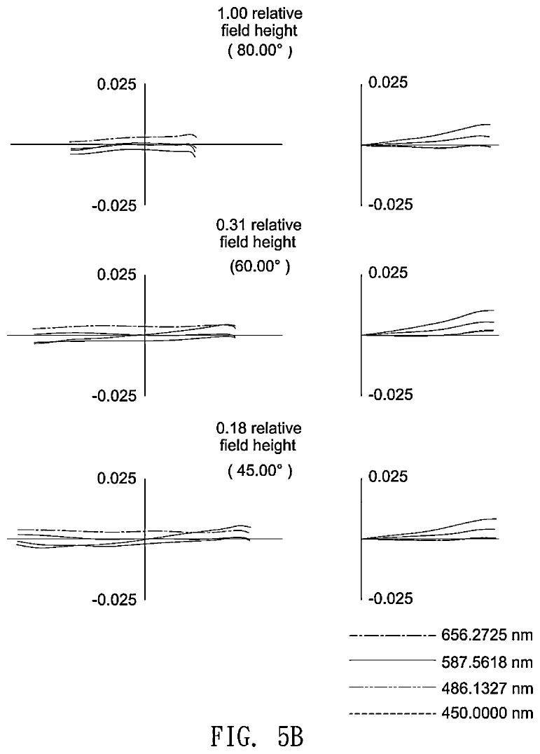

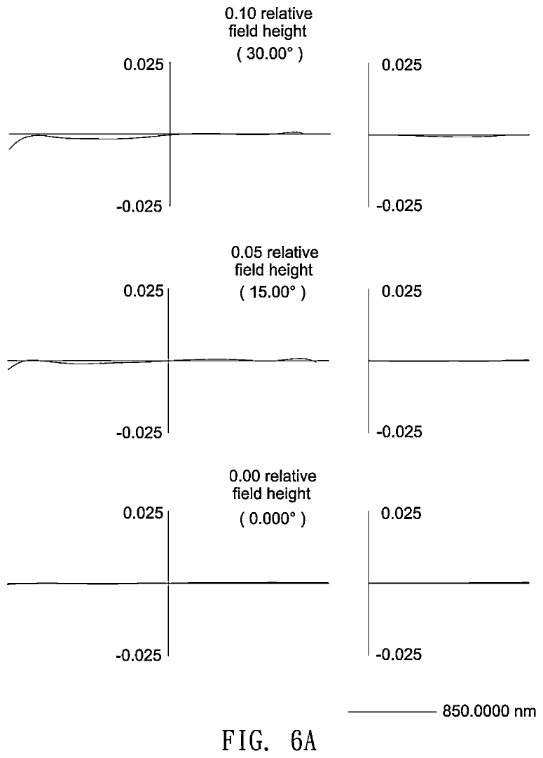

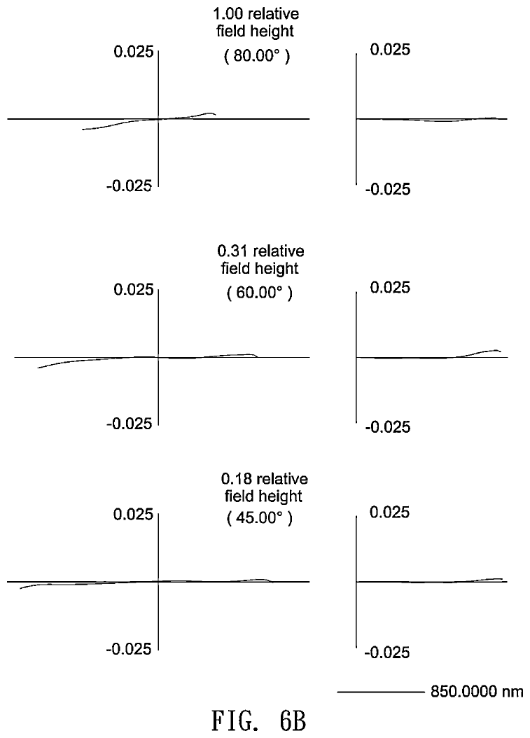

FIG. 5A, FIG. 5B, FIG. 6A and FIG. 6B show optical simulation results of the fixed-focus imaging lens 10b. FIG. 5A and FIG. 5B show ray fan plots for visible light, and FIG. 6A and FIG. 6B show ray fan plots for infrared light (850 nm), where an abscissa of the plot represents entrance pupil positions, and an ordinate of the plot represents relative numerical values of positions on an image plane where chief rays are projected. The optical simulation results for visible light and infrared light imaging shown in these plots are within permitted ranges specified by the standard, which indicates the above embodiment of the fixed-focus imaging lens 10b may achieve good imaging quality for both visible and infrared light.

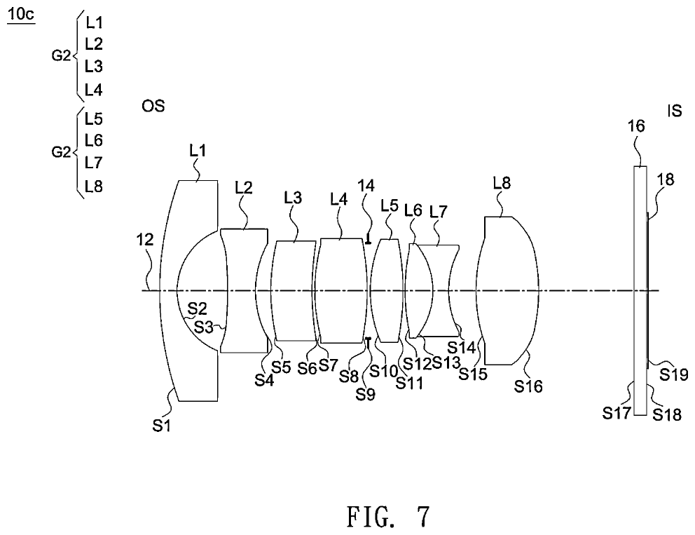

FIG. 7 is a schematic diagram of a fixed-focus imaging lens according to a third embodiment of the invention. In this embodiment, the fixed-focus imaging lens 10c includes a lens L1, a lens L2, a lens L3, a lens L4, a lens L5, a lens L6, a lens L7 and a lens L8 with refractive powers arranged in order from the object side OS to the image side IS, and the imaging lens 10c includes an aperture stop 14 disposed between the lens L4 and the lens L5. The refractive powers of the lens L1 to the lens L8 are respectively negative, negative, positive, positive, positive, positive, negative, and positive. In this embodiment, the lenses L1 and L5 are glass spherical lenses, and the lenses L2, L3, L4, L6, L7 and L8 are plastic aspheric lenses, but the invention is not limited thereto. In this embodiment, the lens L6 and the lens L7 are paired together, such as being cemented to each other, to form a doublet lens to reduce chromatic aberrations of the imaging lens 10c and thus improve the production yield rate of the imaging lens 10c.

In this embodiment, the fixed-focus imaging lens 10c consists essentially of eight lenses with refractive powers. The diagonal field of view (DFOV) of the fixed-focus imaging lens 10c is 160 degrees, BFL=5.8 mm, LT=20.2 mm, GD=0.2 mm, IMH=4.4 mm, EFL-4.03 mm, LT/GD=101, IMH/LT=0.218, EFL/LT=0.1995, and F #=1.9.

Detailed optical data and design parameters of the lenses and other optical components of the fixed-focus imaging lens 10c are shown in Table 5.

TABLE 5

| | | Radius of | Inter- | Refractive | Abbe |
|---|---|---|---|---|---|
| | | curvature | val | index | number |
| Object description | Surface | (mm) | (mm) | (nd) | (Vd) |
| lens L1(meniscus) | S1 | 19.86 | 0.95 | 1.77 | 49.6 |
| | S2 | 3.87 | 2.63 | | |
| lens L2(aspheric) | S3* | 52.81 | 1.58 | 1.54 | 56.11 |
| | S4* | 4.64 | 0.78 | | |
| lens L3(aspheric) | S5* | 10.04 | 2.22 | 1.54 | 56.11 |
| | S6* | 18.36 | 0.10 | | |
| lens L4(aspheric) | S7* | 11.42 | 2.78 | 1.66 | 20.37 |
| | S8* | −19.53 | 0.10 | | |
| aperture stop 14 | S9 | inf | 0.10 | | |
| lens L5(bi-convex) | S10 | 7.95 | 1.77 | 1.59 | 68.62 |
| | S11 | −13.88 | 0.10 | | |
| lens L6(aspheric) | S12* | 10.29 | 1.48 | 1.54 | 56.11 |
| lens L7(aspheric) | S13* | −4.74 | 0.81 | 1.64 | 23.97 |
| | S14* | 5.06 | 1.44 | | |
| lens L8(aspheric) | S15* | 6.57 | 3.36 | 1.54 | 56.11 |
| | S16* | −14.05 | 5.05 | | |
| cover plate 16 | S17 | inf. | 0.70 | 1.52 | 64.17 |
| | S18 | inf. | 0.05 | | |
| image plane 18 | S19 | inf. | 0.00 | | |

Table 6 shows the conic constant and aspheric coefficients for each aspheric surface of the fixed-focus imaging lens 10c.

TABLE 6

| | S3 | S4 | S5 | S6 | S7 | S8 |
|---|---|---|---|---|---|---|
| K | 0.00 | −5.65 | −20.33 | −12.32 | −1.11 | 4.53 |
| A | −7.19E−03 | −3.61E−03 | −6.70E−04 | 1.21E−03 | 2.41E−03 | 5.89E−04 |
| B | 4.67E−04 | 4.21E−04 | −2.53E−05 | −5.03E−04 | −5.05E−04 | −7.05E−05 |
| C | −2.01E−05 | 1.13E−05 | 3.55E−05 | 5.15E−05 | 3.75E−05 | −6.55E−06 |
| D | 4.75E−07 | −1.42E−06 | −2.46E−06 | −2.64E−06 | −1.85E−06 | 2.56E−07 |
| E | 4.97E−09 | 4.47E−08 | — | — | — | — |
| F | −4.17E−10 | −2.67E−09 | — | — | — | — |

| | S12 | S13 | S14 | S15 | S16 |
|---|---|---|---|---|---|
| K | 0.00 | 0.47 | 1.16 | −6.42 | 5.49 |
| A | −1.04E−03 | −1.33E−03 | −4.51E−03 | −7.42E−04 | −1.17E−03 |
| B | −5.31E−05 | 9.10E−04 | 4.14E−04 | −2.71E−05 | −2.48E−05 |
| C | −1.08E−06 | −2.70E−04 | −8.80E−05 | 1.26E−05 | 5.98E−06 |
| D | −1.44E−06 | 3.79E−05 | 7.26E−06 | −3.20E−06 | −8.26E−07 |
| E | 1.10E−07 | −2.02E−06 | −3.63E−07 | 3.01E−07 | 4.76E−08 |
| F | — | — | — | −1.23E−08 | −1.37E−09 |

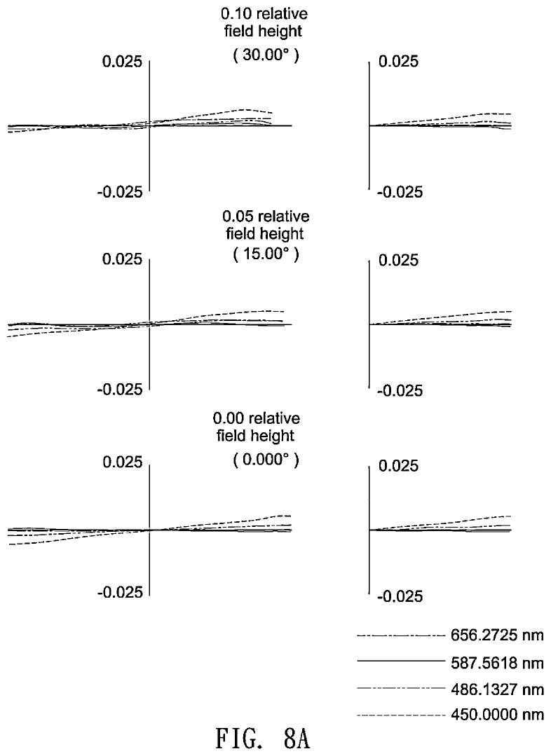

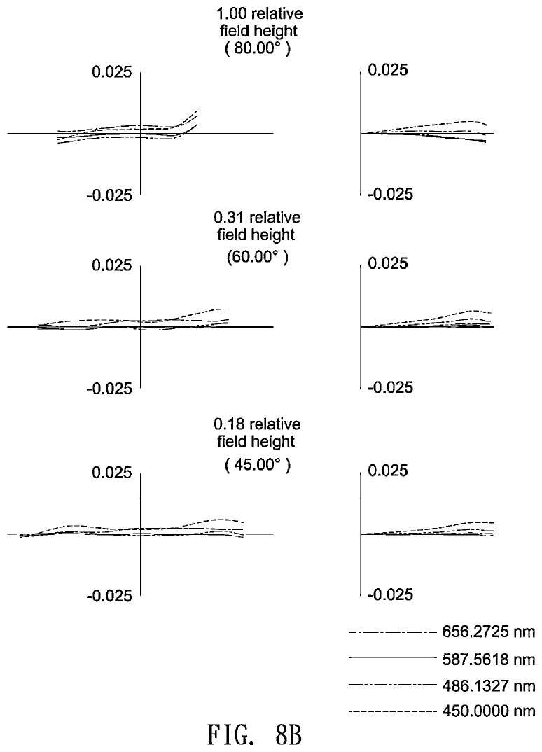

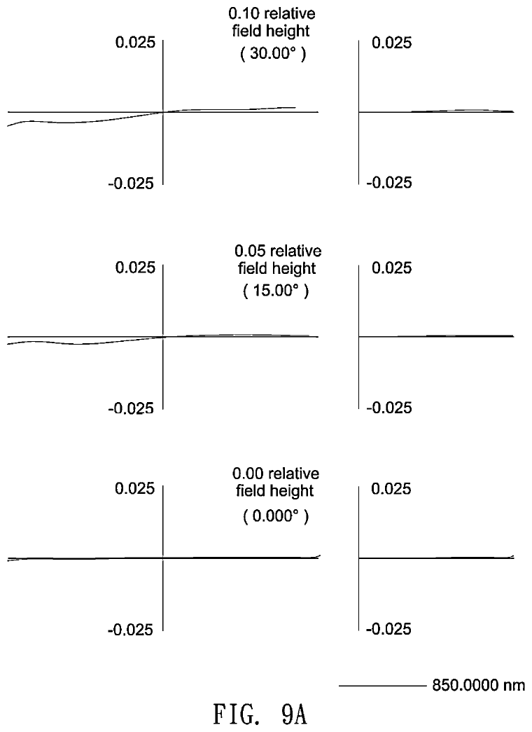

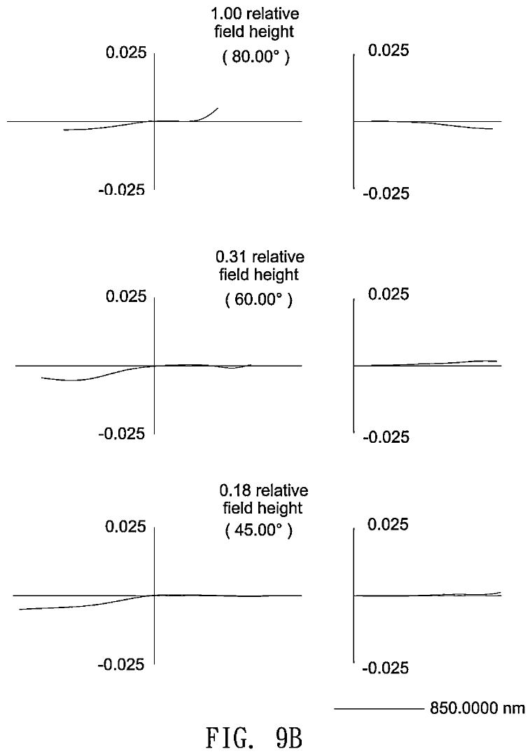

FIG. 8A, FIG. 8B, FIG. 9A and FIG. 9B show optical simulation results of the fixed-focus imaging lens 10c. FIG. 8A and FIG. 8B show ray fan plots for visible light, and FIG. 9A and FIG. 9B show ray fan plots for infrared light (850 nm), where an abscissa of the plot represents entrance pupil positions, and an ordinate of the plot represents relative numerical values of positions on an image plane where chief rays are projected. The optical simulation results for visible light and infrared light imaging shown in these plots are within permitted ranges specified by the standard, which indicates the above embodiment of the fixed-focus imaging lens 10c may achieve good imaging quality for both visible and infrared light.

According to the above embodiments, meeting the designed characteristics and arrangement of optical components set forth in the above may, under the condition of possessing wide field of views and large apertures, achieve good imaging quality for both visible and infrared light imaging and may maintain good imaging quality even for imaging on a sensor with a large target area (for example, an image height up to 4.4 mm). In addition, in various embodiments of the invention, by well matching the glass/plastic lenses and spherical/aspheric lenses and using a glass lens for the lens closest to the object side, the fixed-focus imaging lens is allowed to withstand higher temperatures and a broad range of temperature variations, reduce manufacturing costs, and maintain high imaging qualities.

Though the embodiments of the invention have been presented for purposes of illustration and description, they are not intended to be exhaustive or to limit the invention. Accordingly, many modifications and variations without departing from the spirit of the invention or essential characteristics thereof will be apparent to practitioners skilled in this art. It is intended that the scope of the invention be defined by the claims appended hereto and their equivalents in which all terms are meant in their broadest reasonable sense unless otherwise indicated.

What is claimed is:

1. A fixed-focus imaging lens, comprising:
a first lens group, an aperture stop and a second lens group arranged in order from an object side to an image side of the fixed-focus imaging lens, wherein a total number of lenses with refractive powers of the imaging lens is 7 or 8, the first lens group comprises two plastic aspheric lenses, the second lens group comprises three plastic aspheric lenses, a lens in the first lens group closest to the object side is a glass lens, a diagonal field of view of the imaging lens ranges from 140 to 165 degrees, a distance between a focal plane for infrared light with a wavelength of 850 nm and a focal plane for visible light with a wavelength of 550 nm along an optical axis of the imaging lens is less than 0.01 mm, and the fixed-focus imaging lens satisfies a condition of 45<LT/GD, where LT is a distance measured along the optical axis between two outermost lens surfaces with refractive powers at opposite ends of the imaging lens, and GD is a distance measured along the optical axis between the first lens group and the second lens group.

2. The fixed-focus imaging lens as claimed in claim 1, wherein the second lens group includes a cemented doublet.

3. The fixed-focus imaging lens as claimed in claim 1, wherein a lens in the second lens group closest to the aperture stop is a molded-glass aspheric lens.

4. The fixed-focus imaging lens as claimed in claim 1, wherein the fixed-focus imaging lens satisfies a condition of 0.2<IMH/LT<0.3, where IMH is a maximum image height of the fixed-focus imaging lens.

5. The fixed-focus imaging lens as claimed in claim 1, wherein the fixed-focus imaging lens satisfies a condition of 0.15<EFL/LT<0.25, wherein EFL is an effective focal length of the fixed-focus imaging lens.

6. The fixed-focus imaging lens as claimed in claim 1, wherein a back focal length of the fixed-focus imaging lens ranges from 4 to 8 mm.

7. The fixed-focus imaging lens as claimed in claim 1, wherein an entrance pupil diameter of the fixed-focus imaging lens is greater than 2 mm.

8. The fixed-focus imaging lens as claimed in claim 1, wherein a total track length of the fixed-focus imaging lens ranges from 24 to 28 mm.

9. The fixed-focus imaging lens as claimed in claim 1, wherein the first lens group has a negative refractive power and the second lens group has a positive refractive power.

10. The fixed-focus imaging lens as claimed in claim 1, wherein an F-number of the fixed-focus imaging lens ranges from 1.9 to 2.0.

11. A fixed-focus imaging lens, comprising:
a first lens group comprising a first lens, a second lens and a third lens arranged in order from an object side to an image side of the fixed-focus imaging lens;
a second lens group comprising a fourth lens, a fifth lens, a sixth lens, and a seventh lens arranged in order from the object side to the image side; and
an aperture stop disposed between the third lens and the fourth lens;
wherein the first lens and the fourth lens are glass lenses, the second lens, the third lens, the fifth lens, the sixth lens and the seventh lens are plastic aspheric lenses, a diagonal field of view of the imaging lens ranges from 140 to 165 degrees, a distance between a focal plane for infrared light with a wavelength of 850 nm and a focal plane for visible light with a wavelength of 550 nm along an optical axis of the imaging lens is less than 0.01 mm, and the fixed-focus imaging lens satisfies a condition of 45<LT/GD, where LT is a distance measured along the optical axis between two outermost lens surfaces with refractive powers at opposite ends of the imaging lens, and GD is a distance measured along the optical axis between the first lens group and the second lens group.

12. The fixed-focus imaging lens as claimed in claim 11, wherein the fifth lens and the sixth lens form a cemented doublet.

13. The fixed-focus imaging lens as claimed in claim 11, wherein refractive powers of the first lens, the second lens, the third lens, the fourth lens, the fifth lens, the sixth lens, and the seventh lens are respectively negative, negative, positive, positive, positive, negative and positive.

14. The fixed-focus imaging lens as claimed in claim 11, wherein the fourth lens is a molded glass aspheric lens.

15. The fixed-focus imaging lens as claimed in claim 11, wherein the fixed-focus imaging lens satisfies a condition of 0.2<IMH/LT<0.3, where IMH is a maximum image height of the fixed-focus imaging lens.

16. The fixed-focus imaging lens as claimed in claim 11, wherein the fixed-focus imaging lens satisfies a condition of 0.15<EFL/LT<0.25, wherein EFL is an effective focal length of the fixed-focus imaging lens.

17. The fixed-focus imaging lens as claimed in claim 11, wherein a back focal length of the fixed-focus imaging lens ranges from 4 to 8 mm.

18. The fixed-focus imaging lens as claimed in claim 11, wherein an entrance pupil diameter of the fixed-focus imaging lens is greater than 2 mm.

19. The fixed-focus imaging lens as claimed in claim 11, wherein a total track length of the fixed-focus imaging lens ranges from 24 to 28 mm.

20. The fixed-focus imaging lens as claimed in claim 11, wherein the first lens group further includes an eighth lens with a positive refractive power.
